(19) United States
(12) Patent Application Publication
(10) Pub. No.: US 2006/0089871 A1
(43) Pub. Date: Apr. 27, 2006

(54) System and method for generating advertising sales

(76) Inventor: Kazuhito Takagi, Laguna Hills, CA (US)

Correspondence Address: CHRISTIE, PARKER & HALE, LLP, PO BOX 7068, PASADENA, CA, 91109-7068, US

(21) Appl. No.: 10/949,169

(22) Filed: Sep. 24, 2004

(51) Int. Cl. G06Q 30/00

(52) U.S. Cl. 705/14

(57) ABSTRACT

The system and method described herein generally relate to method and system for generating advertising revenue by promoting products with advertisements placed thereon to a target market where the distribution of such products may be subsidized by advertising revenues. The system and method facilitate sales transactions by, at least at the initial sales transaction, subsidizing the true costs of goods through proceeds from ad placements. Subsequent transactions may be similarly subsidized or be allowed to operate through the theory of supply and demand.

The system and method described herein generally relates to a method for generating advertising revenue by promoting products with advertisements placed thereon to a target market where the distribution of such products may be subsidized by advertising revenues.

### BACKGROUND

Systems and methods of advertising are well known in the art. Common mediums for advertising include newspaper, billboards, the Internet, television, and radio. Advertisements may be used to introduce new products into the market or to introduce existing products to new consumers. Advertising methods may suggest new uses for products already on the market or help facilitate the management of a distribution system. They help to build brands and to foster the good will of an advertiser.

Although systems and methods of advertising revenue are known in the art, there is a continuing need for improved systems and methods. In this manner, it would be desirable to develop an alternative system and method for generating advertising sales.

### SUMMARY

The present invention describes a system and method for generating advertising sales by selecting at least one marketable good of a first cost amount to be distributed, receiving payment for placing at least one ad on or in association with the at least one marketable good, and distributing the at least one marketable good to an entity for a second cost amount, wherein the entity distributes the at least one marketable good to at least one patron for a third cost amount, and wherein the second cost amount is less than or equal to the first cost amount.

Alternatively, the present invention my be practiced by selecting at least one marketable good by a first party to distribute, finding a second party to place an ad on or in association with the at least one marketable good, receiving payment from the second party for the placement of the ad on or in association with the at least one marketable good, receiving the at least one marketable good from a third party for a first cost amount, placing the ad on or in association with the at least one marketable good, and distributing the at least one marketable good to a fourth party for a second cost amount, wherein the fourth party distributes the at least one marketable good to a fifth party for a third cost amount, and wherein the second cost amount is less than or equal to the first cost amount.

In another embodiment, the present invention my be practiced by acquiring a first set of goods at a first unit cost from a first supplier, wherein the first set comprises a plurality of said goods, selling the plurality of goods at a second unit cost to a first purchaser, the second unit cost being priced based in part on advertising venue for placement of ads in connection with the plurality of goods by a first advertising party, selling at least part of the plurality of goods at a third unit cost to a second purchaser, the third unit cost is either zero, less than the first unit cost, or greater than the first unit cost, and selling a second set of plurality of goods at a fourth unit cost to the first purchaser, the fourth unit cost being different from the second unit cost.

### BRIEF DESCRIPTION OF THE DRAWINGS

The invention is best understood from the following detailed description when read in conjunction with the accompanying drawings. Like numerals denote like features throughout the specification and drawings. Included are the following figures:

FIG. 1 is a flow chart of an exemplary system and method for generating advertising sales in accordance with aspects of the present invention;

FIG. 2 is a flow chart of an exemplary system and method for generating advertising sales in accordance with the system and method of FIG. 1 where the target market is restaurants;

FIG. 3 is a flow chart of an alternative embodiment of the system and method for generating advertising sales in accordance with the system and method of FIG. 1 where the target market is retail stores; and

FIG. 4 is a flow chart of an alternative embodiment of the system and method for generating advertising sales in accordance with the system and method of FIG. 1 where the target market is supermarkets.

### DETAILED DESCRIPTION

The detailed description set forth below in connection with the appended drawings is intended as a description of the presently preferred embodiments of the system and method for generating advertising sales provided in accordance with aspects of the present invention and is not intended to represent the only forms in which the present invention may be constructed or utilized. The description sets forth the features and the steps for implementing and using the system and method for generating advertising sales of the present invention in connection with the illustrated embodiments. It is to be understood, however, that the same or equivalent functions and steps may be accomplished by different embodiments, which are also intended to be encompassed within the spirit and scope of the invention. Also, as denoted elsewhere herein, like element numbers are intended to indicate like or similar elements or features.

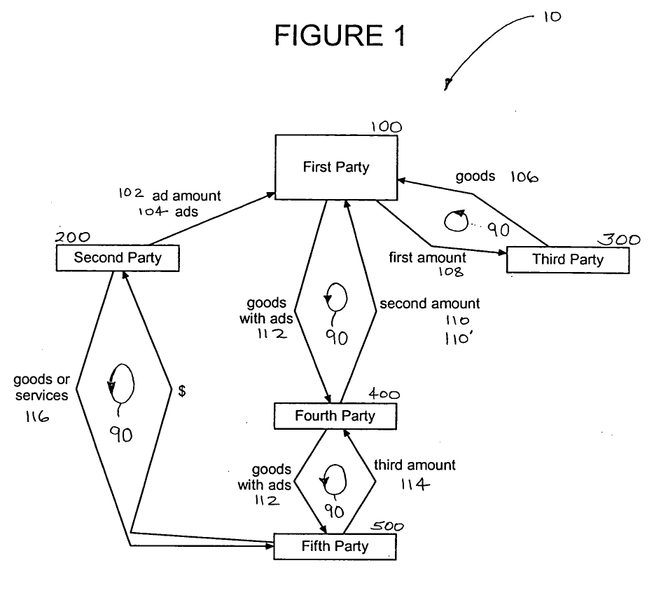

A flow chart of an exemplary system for generating advertising sales provided in accordance with aspects of the present invention is shown in FIG. 1, which is generally designated 10. In one exemplary embodiment, the system for generating advertising sales 10 comprises five groups of parties, with each group of parties comprising one or more members or species of the particular party group. For simplicity, only one member or species per party group is discussed, although it is understood that there may be a plurality of members per party group. In one embodiment, the first party 100 initiates the system by selecting a target market to advertise in and at least one exhaustible good 106 to be used as an advertising vehicle. In one embodiment, the first party 100 may be a promoter, an entrepreneur, or other business entity interested in implementing the system for generating advertising sales 10. The first party 100 solicits a second party 200 to advertise on the goods 106 or on the packaging of the goods. The second party 200 may have a desire to participate in the system 10 due to the attractiveness of the target market. The first party 100 receives from the second party 200 a cost amount 102 for advertising in exchange for ad placements 104 on the goods 106 or on the packaging for the goods. In one embodiment, the second party 200 may be a manufacturer, a corporation, or some other business entity wishing to target the selected market for advertising.

The first party 100 acquires the goods 106 from a third party 300 for a first cost amount 108. In one embodiment, the third party 300 may be a supplier, a wholesaler, a manufacturer, or any other business entity in the business of providing the goods 106. In one embodiment, the first party 100 may be combined with the second party 200 to represent a single entity. In one embodiment, the first party 100 may be combined with the third party 300 to represent a single entity. In one embodiment, the first party 100 may be combined with both the second party 200 and third party 300 to represent a single entity. The first party 100 places the desired ads 104 on either the goods 106 or the packaging of the goods. In one embodiment, the ads 104 may be unrelated to the goods 106 upon which they are placed. The first party 100 distributes the goods with ads 112 to a fourth party 400 doing business in the target market for a second cost amount 110. In one embodiment, the second cost amount 110 may be zero or some amount less than the first cost amount 108. In various embodiments, the fourth party 400 may be a restaurant, a retailer, a supermarket, or some other business entity doing business directly with consumers. The fourth party 400 distributes the goods with ads 112 to a fifth party 500 for a third cost amount 114.

In one embodiment, the fifth party 500 may be a patron, a customer, or a potential customer of the fourth party 400. In an exemplary embodiment, the third cost amount 114 may be zero or some amount greater than zero. Initially, the first party 100 may give away the goods 112 to the fourth party 400 or may offer to sell the goods to the fourth party at some price below its fair market value to spark the interest of the fourth party. The fourth party 400 may also give away the goods 112 for free or sell them at an amount below their fair market value to the fifth party 500 to spark the interest or demand of the fifth party 500. By giving the goods 112 away for free, the first party 100 builds good will with the fourth party 400 who in turn builds good will with the fifth party 500.

In perpetuating the cycle, and due to the demand from the fifth party 500, the fourth party 400 requests additional goods 112 from the first party 100 for a second cost amount 110′, which may be different from the initial second cost amount 110. In one embodiment, the second cost amount 110′ may be zero, greater than zero, or greater than the first cost amount 108. In one embodiment, the fifth party 500 purchases goods or services 116 from the second party 200 as a consequence of the exposure to the second party's ads 104 placed on the goods 112 by the first party 100. After the system 10 is put into motion, the number of goods, the amount for the goods, and the cost to place the ads on the goods can vary in accordance with the economic principles of supply and demand, which are represented by the closed loop cycles 90.

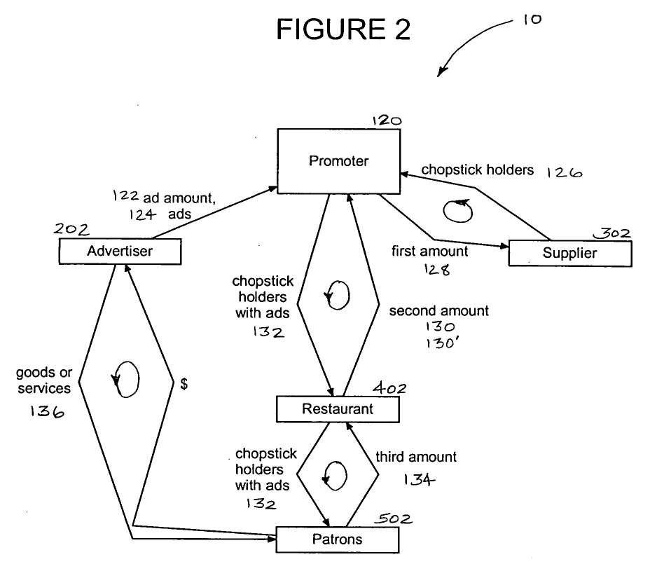

Referring now to FIG. 2, a flow chart of an exemplary system for generating advertising sales in accordance with the system and method of FIG. 1 is shown. In one exemplary embodiment, the system 10 for generating advertising sales may comprise the following parties or groups: an advertiser 202, a promoter 120, a supplier 302, a restaurant 402, and patrons 502 of the restaurant. For simplicity, only one member or species of each group is discussed, although it is understood that there may be more than one advertiser 202, promoter 120, supplier 302, and restaurant 402. In one embodiment, the promoter 120, who may be an entrepreneur or a marketing agent, initiates the system by selecting chopstick holders 126 to be used as the advertising vehicle, i.e., the goods. Alternatively, the promoter 120 may select the target market first and then the goods the target market would be interested in. Still alternatively, the promoter 120 may interview or conduct market surveys with business entities that cater to the target market. In this instance, the promoter 120 may opt to interview the restaurant owner 402 and conclude that chopstick holders are ideal goods for patrons of Asian food providers.

Chopstick holders are well known in the art and described in U.S. Pat. No. 5,810,411 (Major), U.S. Pat. No. 4,721,334 (Nakatsu), U.S. Pat. No. 4,787,633 (Laramie), U.S. Pat. No. 5,486,029 (Kobayashi), the contents of these patents are expressly incorporated herein by reference. Generally speaking, a chopstick holder is a device that comprises two receiving units connected to one another by a bridge or a connector, which functions as a fulcrum. The receiving units each receive an end of a chopstick and the bridge facilitates movement of the chopsticks while preventing the chopsticks from dislodging from the user's hand.

The promoter 120 solicits an advertiser 202 to advertise on the chopstick holders 126 or on the packaging of the chopstick holders. The advertiser 202 may be one of many businesses that sell products in a restaurant, a supermarket, a hardware store, or any other business entity that would find restaurant patrons to be a prime demographic for advertising. The promoter 120 receives an amount 122 for advertising from the advertiser 202 and the desired ad or ads 124 to be placed on the chopstick holders 126 or on their packaging.

The promoter 120 acquires the chopstick holders 126 from a supplier 302 for a first amount 128. In one embodiment, the supplier 302 may be a manufacturer, a wholesaler, or any other business entity that provides chopstick holders. The promoter 120 places the desired ads 124 on either the chopstick holders 126 or the packaging of the chopstick holders. In practice, the manufacturer of the chopstick holders may place the ads on the goods or on the packaging directly at the request of the promoter 120. The promoter 120 distributes the chopstick holders with ads 132 to the restaurant 402 for a second amount 130. In one embodiment, the second amount 130 may be zero or some amount less than the first amount 128 to entice the restaurant 402 to distribute the chopstick holders 132 to its patrons. The restaurant 402 then distributes the chopstick holders with ads 132 to the patrons 502 for a third amount 134. In one embodiment, the third amount 134 may be zero or some de minimus amount as a gesture to build customer loyalty or good will.

In perpetuating the cycle, and because the initial supply of goods has run out or simply because of the demand from patrons 502, the restaurant 402 requests additional chopstick holders with ads 132 for a second amount 130′, which may be different from the initial second amount 130. In one embodiment, the second amount 130′ may be zero, greater than zero, or greater than the first amount 128. In one embodiment, the patrons 502 of the restaurant 402 purchase goods or services 136 from the advertiser 202 as a consequence of exposure to the ads 124. After the system 10 is put into motion, the number of chopstick holders, the amount for the chopstick holders, and the cost to place the ads between party groups can vary in accordance with supply and demand.

In an alternative embodiment, the promoter 120 may initiate the system 10 by sending a package containing a plurality of goods 126 with ads 124 placed thereon to the restaurant 402, or a host of random restaurants. Of course, the sent packages would include information for ordering additional goods. The restaurant 402 then distributes the goods to its patrons, either at a small cost or for free. Once the restaurant 402 runs out of chopstick holders 126, it requests a new order or a refill from the promoter 120, who then orders from the supplier 302. The system 10 would then evolve as discussed above with four chains or cycles of supply and demand and one chain of advertising.

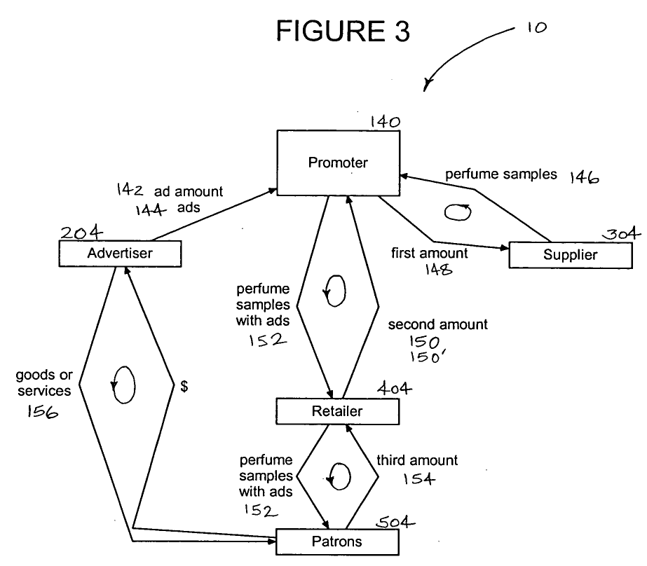

Referring now to FIG. 3, a flow chart of an alternative embodiment of the system and method for generating advertising sales in accordance with the system of FIG. 1 is shown. In one exemplary embodiment, the system for generating advertising sales 10 may comprise the following groups: an advertiser 204, a promoter 140, a supplier 304, a retailer 404, and patrons 504 of the retailer. For simplicity, only one member or species of each group is discussed, although it is understood that there may be more than one advertiser 204, promoter 140, supplier 304, and retailer 404. In one embodiment, the promoter 140 initiates the system by selecting perfume samples 146 to be used as the advertising vehicle. In one embodiment, the promoter 140 is an entrepreneur or other business entity interested in implementing the system for generating advertising sales 10. The promoter 140 solicits an advertiser 204 to advertise on the perfume samples 146 or on the packaging of the perfume samples. The promoter 140 receives an amount for advertising 142 from the advertiser 204 and the desired ads 144. In one embodiment, the advertiser 204 may be a manufacturer, a corporation, or some other business entity wishing to target the selected market for advertising. As perfume samples are the goods being promoted, the target market or patrons may include female shoppers or visitors of health spas and salons. The market segment that caters to these patrons may include salons, health spas, and clothing stores.

The promoter 140 acquires the perfume samples 146 from a supplier 304 for a first amount 148. In one embodiment, the supplier 304 may be a manufacturer, a wholesaler, or any other business entity providing perfume samples 146. The promoter 140 places the desired ads 144 on either the perfume samples 146 or the packaging of the perfume samples. The promoter 140 distributes the perfume samples with ads 152 to a retailer 404 for a second amount 150. In one embodiment, the second amount 150 may be zero or some amount less than the first amount 148 to entice the retailer 404 to distribute the perfume samples 152. As discussed above, in one embodiment, the retailer 404 may be a department store, a salon, a health spa, a perfume store, or any other business entity wishing to distribute perfume samples 146. The retailer 404 distributes the perfume samples with ads 152 to patrons 504 for a third amount 154. In one embodiment, the third amount 154 may be zero.

In perpetuating the cycle, and because of the demand from the patrons 504, the retailer 404 requests additional perfume samples with ads 152 for a second amount 150′, which may be different from the initial second amount 150. In one embodiment, the second amount 150′ may be zero, greater than zero, or greater than the first amount 148. In another embodiment, the patrons 504 of the retailer 404 purchase goods or services 156 from the advertiser 204 as a consequence of exposure to the ads 144. After the system 10 is put into motion, the number of perfume samples, the amount for the perfume samples, and the cost to place the ads between party groups can vary in accordance with supply and demand.

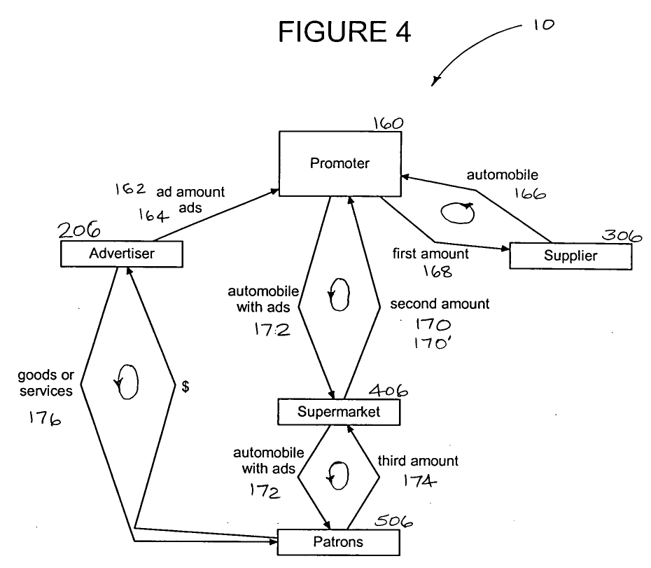

Referring now to FIG. 4, a flow chart of an alternative embodiment of the system and method for generating advertising sales in accordance with the system of FIG. 1 is shown. In one exemplary embodiment, the system and method for generating advertising sales 10 comprises the following parties or groups: an advertiser 206, a promoter 160, a supplier 306, a supermarket 406, and patrons 506 of the supermarket. For simplicity, only one member or species of each group is discussed, although it is understood that there may be more than one advertiser 206, promoter 160, supplier 306, and supermarket 406. In one embodiment, the promoter 160 initiates the system by selecting an automobile 166 to be used for advertising. In one embodiment, the promoter 160 is an entrepreneur or other business entity interested in implementing the system for generating advertising sales 10. The promoter 160 solicits an advertiser 206 to advertise on or in association with the automobile 166. The promoter 160 receives an amount for advertising 162 from the advertiser 206 in return for placement of the desired ads 164 on the automobile 166. In one embodiment, the advertiser 206 may be a manufacturer, a corporation, or some other business entity wishing to target the selected market for advertising. As the automobile 166 is the good to be promoted, the patrons may include race car fans, members of a golf club, customers of a new supermarket in a car give-away sweepstake, customers of a new department store car give-away sweepstake, etc.

The promoter 160 acquires the automobile 166 from a supplier 306 for a first amount 168. In one embodiment, the supplier 306 may be a manufacturer, a dealer, or any other business entity providing automobiles. The promoter 160 places the desired ads 164 on either the automobile 166 or on associated displays to be placed adjacent the automobile. The promoter 160 distributes the automobile with ads 172 to a supermarket 406 for a second amount 170. In one embodiment, the second amount 170 may be zero or some amount less than the first amount 168 to entice the supermarket 406 to distribute the automobile 172. The supermarket 406 distributes the automobile with ads 172 to patrons 506 for a third amount 174. In one embodiment, the third amount 174 may be zero. In a preferred embodiment, the automobile 166 is given away by the supermarket 406 in a contest. The patrons 506 may pay a fee to enter the contest, in which case the third amount 174 is greater than zero.

In perpetuating the cycle, and because of the demand from patrons 506, the supermarket 406 requests additional automobiles 172 for a second amount 170′, which may be different from the initial second amount 170. In a preferred embodiment, the request to the promoter 160 for additional automobiles 172 may come from the supermarket 406, a related supermarket, a competing supermarket, or any other store. In one embodiment, the second amount 170′ may be zero, greater than zero, or greater than the first amount 168. In one embodiment, the patrons 506 of the supermarket 406 purchase goods or services 176 from the advertiser 206 as a consequence of exposure to the ads 164 of the advertiser 206. After the system 10 is put into motion, the number of automobiles, the amount for the automobiles, and the cost to place the ads can vary in accordance with supply and demand.

Although the preferred embodiments of the invention have been described with some specificity, the description and drawings set forth herein are not intended to be delimiting, and persons of ordinary skill in the art will understand that various modifications may be made to the embodiments discussed without departing from the scope of the invention, and all such changes and modifications are intended to be encompassed within the appended claims. Various changes to the number of parties involved may be made without deviating from the spirit and scope of the present invention. For example, various parties may be added to the interactions involving the first party. In addition, while the specification define the parties in terms of first, second, third, etc., the sequence can change. In other words, in the context of one transaction, a party may be referred to as a first party. However, in the context of another transaction, the same party may be referred to as a second or a third party. In the event of a conflict, the positions or blocks of various parties shown in the figures should control and not their numeric designations. Other changes include the use of a service instead of a good as the advertisement vehicle. Accordingly, many alterations and modifications may be made by those having ordinary skill in the art without deviating from the spirit and scope of the invention.

What is claimed is:

1. A method for generating sales comprising the steps:
selecting at least one marketable good of a first cost amount to be distributed;
receiving payment for placing at least one ad on or in association with the at least one marketable good; and
distributing the at least one marketable good to an entity for a second cost amount, wherein the entity distributes the at least one marketable good to at least one patron for a third cost amount,
wherein the second cost amount is less than or equal to the first cost amount.

2. The method of claim 1, further comprising the step of receiving an order for additional goods at a second amount from the first party.

3. The method of claim 1, wherein the at least one marketable good is a chopstick holder.

4. The method of claim 1, wherein the at least one marketable good is a perfume sample.

5. The method of claim 1, wherein the at least one marketable good is a automobile.

6. The method of claim 1, wherein the entity is a restaurant.

7. The method of claim 1, wherein the entity is a retailer.

8. The method of claim 1, wherein the entity is a supermarket.

9. The method of claim 1, wherein the second cost amount is zero.

10. The method of claim 1, wherein the third cost amount is zero.

11. The method of claim 1, wherein the at least one ad is unrelated to the at least one marketable good upon which the at least one ad is placed.

12. A method for generating sales comprising the steps:
selecting at least one marketable good by a first party to distribute;
finding a second party to place an ad on or in association with the at least one marketable good;
receiving payment from the second party for the placement of the ad on or in association with the at least one marketable good;
receiving the at least one marketable good from a third party for a first cost amount;
placing the ad on or in association with the at least one marketable good; and
distributing the at least one marketable good to a fourth party for a second cost amount, wherein the fourth party distributes the at least one marketable good to a fifth party for a third cost amount,
wherein the second cost amount may be less than, equal to, or greater than the first cost amount.

13. The method of claim 12, further comprising the step of the fifth party purchasing goods or services from the second party.

14. The method of claim 12, further comprising the step of receiving an order for additional marketable goods from the fourth party.

15. The method of claim 12, wherein the at least one marketable good is a chopstick holder.

16. The method of claim 12, wherein the at least one marketable good is a perfume sample.

17. The method of claim 12, wherein the at least one marketable good is a automobile.

18. The method of claim 12, wherein the fourth party is a restaurant.

19. The method of claim 12, wherein the fourth party is a retailer.

20. The method of claim 12, wherein the fourth party is a supermarket.

21. A method for perpetuating purchase and sale cycles through advertising revenue comprising:
acquiring a first set of goods at a first unit cost from a first supplier, wherein the first set comprises a plurality of said goods;
selling the plurality of goods at a second unit cost to a first purchaser; the second unit cost being priced based in part on advertising venue for placement of ads in connection with the plurality of goods by a first advertising party;
selling at least part of the plurality of goods at a third unit cost to a second purchaser, the third unit cost is either zero, less than the first unit cost, or greater than the first unit cost; and
selling a second set of plurality of goods at a fourth unit cost to the first purchaser, the fourth unit cost being different from the second unit cost.
